(19) United States
(12) Patent Application Publication
(10) Pub. No.: US 2016/0115076 A1
(43) Pub. Date: Apr. 28, 2016

(54) Compositions Comprising One or More Calcium-Magnesium Compounds in the Form of Compacts

(71) Applicant: S. A. LHOIST RECHERCHE ET DEVELOPPEMENT, Ottignies-Louvaiv-la-Neuve (BE)

(72) Inventors: Guillaume Criniere, Braine l'Alleud (BE); Thierry Chopin, Uccle (BE)

(21) Appl. No.: 14/895,401

(22) PCT Filed: Jul. 11, 2014
(86) PCT No.: PCT/EP2014/064982

§ 371 Date: Dec. 2, 2015

(30) Foreign Application Priority Data
Jul. 15, 2013 (BE) 2013/0485
Apr. 22, 2014 (BE) 2014/0280

(51) Int. Cl. C04B 9/00; C04B 14/30; C04B 14/36; C04B 16/00

(52) U.S. Cl. CPC C04B 9/00; C04B 16/00; C04B 14/308; C04B 14/36

(57) ABSTRACT

A composition comprising at least one calcium-magnesium compound fitting the formula aCaCO₃.bMgCO₃.xCaO.yMgO.zCa(OH)₂.tMg(OH)₂.uI, wherein I represents impurities a, b, z, t and u each being mass fractions ≧0 and ≦50%, x and y each being mass fractions ≧0 and ≦100%, with x+y≧50% by weight, based on the total weight of said at least one calcium-magnesium compound, which is in the form of particles, said composition having an calcium and magnesium accrued content in the form of oxides, greater than or equal to 20% by weight and being in the form of compacts, each compact being formed with said compacted and shaped particles of calcium-magnesium compounds, said compacts having a Shatter Test Index of less than 10% allowing very good resistance to falling and good resistance to ageing, manufacturing method and use thereof.

The present invention relates to a composition comprising at least one calcium-magnesium compound fitting the formula aCaCO₃.bMgCO₃.xCaO.yMgO.zCa(OH)₂.tMg(OH)₂.uI, wherein represents impurities, a, b, z, t and u each being mass fractions ≧0 and ≦50%, x and y each being mass fractions ≧0 and ≦100%, with x+y≧50% by weight, based on the total weight of said at least one calcium-magnesium compound, said composition having an calcium and magnesium accrued content in the form of oxides, greater than or equal to 20% by weight based on the total weight of the composition.

Calcium-magnesium compounds are used in many industries, such as for example steel-making, treatment of gases, treatment of waters and sludges, agriculture, building industry, civil engineering, . . . . They may be used either as rocks, or as fines (size of typically less than 7 mm). In certain industries, the rock shape is nevertheless preferred. For example this is the case in steel-making during the addition of calcium-magnesium compounds in oxygen converters or in electric arc furnaces.

Lime producers always maintain a material balance between rock calcium-magnesium compounds and the fines generated before and during calcination as well as during subsequent handlings and operations. Nevertheless in certain cases, an excess of fines is produced. These fines may then be agglomerated together in the form of briquettes or the like, which not only gives the possibility of removing the excessive fines but also of artificially increasing the production of rock calcium-magnesium compounds by adding these briquettes or the like.

These briquettes or the like generally have a lower mechanical strength than that of rock calcium-magnesium compounds. They often have also a resistance to ageing during their storage or their handling which is much lower than that of rock calcium-magnesium compounds. Generally, it is the presence of macrodefects which is at the origin of these poorer properties but also the absence of strong chemical bonds at the interface between the grains. This explains that in practice, the briquetting of the fines of calcium-magnesium compounds is for the moment not very used industrially. Considering the poor quality of the compacts formed by this type of method, it is estimated that briquetting provides a yield of less than 50% as there are so many unusable compacts at the output of this type of method which requires a recycling step.

In the sense of the present invention, by the terms of macrodefects, are meant any type of clefts, cracks, cleaving planes and the like, observable with the naked eye, under an optical microscope or else with a scanning electron microscope (SEM).

Over the years, several additives such as for example calcium stearate or paper fibers were used for increasing the strength and the durability of the briquettes or the like of calcium-magnesium compounds but without leading to sufficient improvements. Moreover, in many cases, the use of additives currently used for other shaped industrial products is limited, as this is notably the case for the manufacturing of briquettes of calcium-magnesium compounds either because the calcium-magnesium compounds violently react with water, or due to a potential negative effect of these additives on the final use of the briquettes of calcium-magnesium compounds.

U.S. Pat. No. 7,105,114 claims a briquetting method for (dolomitic) quick lime fines using from 0.5 to 5% by weight of binders containing pseudo-plastic carbon chains which significantly improve the mechanical properties of the briquettes and which do not have the inconveniences mentioned earlier. The method nevertheless only leads to obtaining briquettes for which half of them are broken after a fall between 0.9 and 1.8 m (a fall between 3 and 6 feet), which represents completely insufficient mechanical strength.

Briquettes or the like based on calcium-magnesium compounds may also be consolidated by performing a heat treatment at a very high temperature which leads to the sintering of said briquettes or the like. For example in the case of burnt dolomite briquettes, it is known that a heat treatment from one to a few hours at a temperature above 1,200° C., and even ideally above 1,300° C., leads to an increase in the mechanical properties of said briquettes. Such a heat treatment at very high temperature nevertheless leads to an evolution in the textural characteristics of the aforesaid briquettes, notably it leads to a strong reduction both of the specific surface area and of the pore volume. This is also accompanied by a strong reduction in reactivity to water as described in the EN 459-2:2010 E standard, which has many problems for certain applications.

Therefore, there is a real need for developing a compact product containing a calcium-magnesium compound which would be distinguished from the products in the form of briquettes as currently known by a very clear improvement in resistance to falling, as well as preferably by much better resistance to ageing in a humid atmosphere, while preserving the intrinsic properties (structural characteristics) of the calcium-magnesium compound before shaping, in particular its specific surface area and/or its pore volume.

The object of the invention is to overcome the drawbacks of the state of the art by providing a composition in the form of a compact product, comprising at least one calcium-magnesium compound fitting the formula CaCO₃.bMgCO₃.xCaO.yMgO.zCa(OH)₂.tMg(OH)₂.uI, wherein I represents impurities, a, b, z, t and u each being mass fractions ≧0 and ≦50%, x and y each being mass fractions ≧0 and ≦100%, with x+y≧50%, said composition having an calcium and magnesium accrued content in the form of oxides, greater than or equal to 20% by weight based on the total weight of the composition, said compact product being distinguished from products known so far by presenting a particularly high resistance to falling as well as a good resistance to ageing in a humid atmosphere, while having advantageous textural characteristics, in particular a high specific surface area and/or a high pore volume.

This compact product is preferably a compact product based on calcium and/or magnesium oxide, for example comprising calcitic, magnesian or dolomitic quick lime or quick dolomite. In this product, a, b, z, t and u may take any value between 0 and 50%.

The composition may originate from a natural product, more or less burnt, more or less hydrated or not, but which will always comprise at least 50% by weight of quick products, i.e. based on calcium and/or magnesium oxide. The composition may also stem from a mixture of one or several calcium or magnesium compounds. The composition may comprise more than one calcium-magnesium compound as described above or other added mineral or organic products.

The CaCO₃. MgCO₃, CaO, MgO, Ca(OH)₂ and Mg(OH)₂ contents in calcium-magnesium compounds may easily be determined with conventional methods. For example, they may be determined by X fluorescence analysis, the procedure of which being described in the EN 15309 standard, coupled with a measurement of the loss on ignition and a measurement of the CO₂ volume both according to the EN 459-2:2910 E standard.

The contents of calcium and magnesium in the form of oxides in the composition may also, in the most simple cases, be determined with the same methods. In more complicated cases, such as for example compositions containing diverse mineral or organic additives, one skilled in the art will be able to adapt the battery of characterization techniques to be applied for determining these contents of calcium and magnesium in the form of oxides. As an example and in a non-exhaustive way, it is possible to resort to thermogravimetric analysis (TGA) and/or thermodifferential analysis (TDA), optionally performed under an inert atmosphere, or alternatively to X-ray diffraction analysis (XRD) associated with a semi-quantitative analysis of the Rietvelt type.

In order to solve this problem, a composition as indicated in the beginning, is provided according to the invention, characterized in that said at least one calcium-magnesium compound is in the form of particles, said composition being in the form of compacts, each compact being formed with at least said compacted and shaped particles of calcium magnesium compounds, said compacts having a shatter test index of less than 10%.

By compact, is meant fines or mixtures of fines (with a size typically below 7 mm) which are compacted or compressed. These compacts generally appear in the form of tablets or briquettes.

By tablet, in the sense of the present invention is meant objects shaped with a technology for compacting or compressing fines resulting from the combined action of two pistons (one in the high position, the other in the low position) on said fines placed in a cavity. The term of tablet therefore includes whole shaped objects belonging to the family of tablets, pellets or compressed tablets, and more generally objects with diverse three dimensional shapes such as cylindrical, octagonal, cubic or rectangular shapes for example. Said technology generally uses rotary presses or hydraulic presses.

By briquette, in the sense of the present invention is meant objects shaped with a technology for compacting or compressing fines resulting from the combined action of two tangential rollers (generally cylinders provided with cavities forming molds substantially corresponding to the desired shape and dimensions of the briquette) on said fines, the supply of which is forced by a worm screw. The term of briquette therefore includes whole shaped objects belonging to the family of briquettes, pebbles, soap bars or platelets. Said technology generally uses presses with tangential rollers.

By the term of Shatter Test index, in the sense of the present invention, is meant the mass percentage of the fines of less than 10 mm generated after 4 two-meter falls with initially 0.5 kg of product with a size of more than 10 mm. These 4 falls are achieved by using a tube with a length of 2 m and a diameter of 40 cm with a removable bottom (receptacle). The base of the receptacle is a polypropylene plate with a thickness of 3 mm. The receptacle rests on a concrete ground.

We can easily distinguish the compact product in the form of tablets or briquettes according to the present invention from the rock products resulting from calcination of limestone or dolomite rocks, by considering the internal structure. By a simple naked eye observation, with an optical microscope or with a scanning electron microscope (SEM), the constitutive particles of the compact product from the invention may easily be shown, unlike the rock products resulting from calcination which have a homogeneous surface in which the constitutive particles are indiscernible.

Moreover the compact product in the form of tablets or briquettes according to the present invention will be distinguished from the products in the form of briquettes and the like known hitherto, by also considering the internal structure. The compact product from this invention is free from macroscopic defects or macrodefects, such as clefts or cracks, which have a negative influence on the resistance to falling, unlike the products in the form of briquettes and the like known so far, which contain cracks from a few hundred micrometers to a few millimeters in length and from a few micrometers to a few hundred micrometers in width which may easily be detected by simple naked eye observation, under an optical microscope or else under a scanning electron microscope (SEM).

According to the present invention, the composition appears as a compact product highly resistant to falling and to ageing in a humid atmosphere, which is particularly important for subsequent uses where fines cannot be applied. The composition according to the invention therefore allows the utilization of fine calcium-magnesium compound particles having a d₁₀₀ of less than or equal to 7 mm in applications of calcium-magnesium compounds, which were not allowed up to now.

Said at least one calcium-magnesium compound according to the present invention is therefore at least formed with quick lime, quick dolomitic lime, quick magnesian lime or dolime resulting from the calcination of natural limestones or dolomites.

The impurities notably comprise all those which are encountered in natural limestones and dolomites, such as clays of the silico-aluminate type, silica, impurities based on iron or manganese, . . . .

The composition according to the invention may therefore also comprise calcium or magnesium carbonates such as unburnt materials from the calcination of natural limestones or dolomites or products resulting from the recarbonation of calcium-magnesium compounds. Finally it may also comprise calcium or magnesium hydroxides resulting from the hydration (slaking) of calcium-magnesium compounds.

In an alternative of the composition according to the invention, the calcium-magnesium compounds originate completely or partly from the recycling of co-products, notably from slags present in the steel industry converters. Such slags typically have a mass content from 40 to 70% of CaO and from 3 to 15% of MgO.

In an advantageous alternative according to the present invention, said at least one calcium-magnesium compound presents mass fractions such that x+y≧60%, preferably ≧75%, preferentially ≧80%, and even more preferentially ≧90%, more particularly ≧93%, or even ≧95% by weight, based on the total weight of said at least one calcium-magnesium compound.

In this advantageous alternative, said at least one calcium-magnesium compound is in majority a compound based on calcium and/or magnesium oxide and therefore is a quick calcium-magnesium compound.

In another advantageous embodiment, the composition according to the invention has an accrued content of calcium and magnesium in the form of oxides, greater than or equal to 40% by weight, advantageously ≧60% by weight, preferably ≧80% by weight, in particular ≧90% by weight, preferentially ≧93% by weight, or even equal to 95% by weight based on the total weight of the composition.

Advantageously, said compacts have a Shatter Test Index of less than 8%. More particularly, according to the present invention, said compacts have a Shatter Test Index of less than 6%. More advantageously, said compacts have a Shatter Test Index of less than 4%. And even more advantageously, said compacts have a Shatter Test Index of less than 3%.

Advantageously, the composition according to the present invention has a specific surface area measured by manometry with adsorption of nitrogen after degassing under vacuum at 190° C. for at least 2 hours and calculated according to the multipoint BET method as described in the ISO 9277:2010E standard, greater than or equal to 0.4 m²/g, preferably greater than or equal to 0.6 m²/g, more preferentially greater than or equal to 0.8 m²/g and even more preferentially greater than or equal to 1.0 m²/g and in particular greater than or equal to 1.2 m²/g, which is much greater than that of sintered products which generally have a specific surface area of less than or equal to 0.1 m²/g.

In this way, the composition has a relatively high specific surface area as compared with the above sintered briquettes notably by preserving the intrinsic properties/structural characteristics of the calcium-magnesium compound before its shaping.

Said composition is also characterized in that its total pore volume (determined by porosimetry with intrusion of mercury according to Part 1 of the ISO 15901-1:2005E standard which consists of dividing the difference between the skeleton density measured at 30,000 psia, (207 Mpa), and the apparent density, measured at 0.51 psia (3.5 kPa), by the skeleton density) is greater than or equal to 20%, preferably greater than or equal to 25% and even more preferentially greater than or equal to 30%, which is much greater than that of sintered products which generally have a total pore volume of less than or equal to 10%.

Advantageously, the composition according to the invention has a relatively high total pore volume as compared with the above sintered briquettes, notably by preserving the intrinsic properties/structural characteristics of the calcium-magnesium compound before shaping.

Advantageously, said composition has a homogeneous density distribution within the compact. Indeed, the proposed compaction method using a uniaxial press allows formation of compacts where the density is substantially the same along the longitudinal direction (i.e. along the longitudinal displacement axis of the punches) and along the transverse direction (i.e. perpendicularly to the longitudinal displacement axis of the punches).

A low density gradient may exist along the longitudinal direction notably when only one of the punches is in motion relatively to the other one, the highest density being found on the side of the active punch, and the lowest density being found on the opposite side where the punch is inactive.

According to the present invention, said compacts also have a Shatter Test Index of less than 20%, preferably less than 10% after an Accelerated Ageing Test of level 1 at 30° C. under 75% of relative humidity (i.e. 22.8 g/m³ of absolute humidity) for 2 hours.

By Accelerated Ageing Test, in the sense of the present invention, is meant ageing for 2 hours made in a climatic chamber starting with 0.5 kg of product with a size greater than or equal to 10 mm placed as a monolayer on a grid itself placed above a receptacle, so that the contact between the product and the humid atmosphere is optimum, i.e. each of said constitutive compacts of the product is spaced apart from the other compacts by at least 1 cm. The increase in the mass during ageing quantifies the water absorption and therefore the hydration of the composition.

The Shatter Test Index measured after ageing is obtained starting with the totality of the product, which means that even if the Accelerated Ageing Test has generated by itself fines, they are properly counted in the final result. The Accelerated Ageing Test may be carried out under different temperature and relative humidity conditions—and therefore of absolute humidity—so as to modulate its intensity. Four intensity levels ranging from 1 (the less severe test) to 4 (the most severe test) were used:
Level 1: 30° C. and 75% of relative humidity leading to an absolute humidity of 22.8 g/m³;
Level 2: 40° C. and 50% of relative humidity leading to an absolute humidity of 25.6 g/m³;
Level 3: 40° C. and 60% of relative humidity leading to an absolute humidity of 30.7 g/m³;
Level 4: 40° C. and 70% of relative humidity leading to an absolute humidity of 35.8 g/m³.

Advantageously, said compacts have a Shatter Test Index of less than 20%, preferably less than 10%, after an Accelerated Ageing Test of Level 2 at 40° C. under 50% of relative humidity (i.e. 25.6 g/m³ of absolute humidity) for 2 hours.

More advantageously, said compacts have a Shatter Test Index of less than 20%, preferably less than 10%, after an Accelerated Ageing Test of Level 3 at 40° C. under 60% of relative humidity (i.e. 30.7 g/m³ of absolute humidity) for 2 hours.

Even more advantageously, said compacts have a Shatter Test Index of less than 20%, in particular less than 10%, more particularly, less than 5% and even most particularly less than 3%, after an accelerated ageing test of Level 4 at 40° C. under 70% of relative humidity (i.e. 35.8 g/m³ of absolute humidity) for 2 hours.

According to the present invention, the compact may contain organic additives such as for example binders or lubricants but it may also be free of these organic additives.

The organic carbon percentage present in the composition according to the invention may be calculated by the difference between the total carbon percentage and the percentage of carbon of mineral origin. The total carbon percentage is for example measured by carbon/sulfur (C/S) analysis according to the ASTM 025 (1999) standard and the percentage of carbon of mineral origin is determined for example by dosing the CO₂ volume according to the EN 459-2:2010 E standard.

In a particular embodiment of the composition according to the invention, said particles have a size of less than or equal to 7 mm, observable by optical microscopy or scanning electron microscopy and before compaction have a particle size d₁₀₀ of less than or equal to 7 mm, in particular less than or equal to 5 mm, as for example measured by sieving.

According to the present invention, the composition therefore appears as compacts which are initially obtained starting with fines constituted by particles of calcium-magnesium compounds having a d₁₀₀ of less than or equal to 7 mm and which are finally highly resistant to falling and to ageing in a humid atmosphere, which is particularly important for subsequent uses where the fines cannot be applied. The composition according to the invention therefore allows inter alia, as noted above, the utilization of fine particles of calcium-magnesium compounds having a d₁₀₀ of less than or equal to 7 mm, in applications of calcium-magnesium compounds which were not allowed up to now.

The notation dx represents a diameter expressed in mm, relatively to which X % by mass of the measured particles are smaller or equal.

In a particular advantageous embodiment of the invention, said particles of calcium-magnesium compounds before compaction have a d₉₀ of less than or equal to 3 mm, in particular less than or equal to 2 mm.

More particularly, said particles of calcium-magnesium compounds before compaction have a d₅₀ of less than or equal to 1 mm, in particular less than or equal to 500 μm, and a do greater than or equal to 0.1 μm, in particular greater than or equal to 0.5 μm, in particular greater than or equal to 1 μm.

According to another advantageous embodiment of the present invention, said compacts are of a regular and homogeneous shape, characteristic of products obtained by methods for shaping fines via a dry route, for example selected from the group of tablets or briquettes, and have a size comprised between 10 and 100 mm, preferably greater than or equal to 15 mm, preferably greater than or equal to 20 mm, and preferably less than or equal to 70 mm, in particular less than or equal to 50 mm.

By size of the compacts is meant that of those which cross through a sieve or screen, for example with square meshes.

More particularly, in the sense of the present invention, said compacts have an average weight per compact of at least 1 g, preferably of at least 5 g, preferentially of at least 10 g and in particular of at least 15 g.

In a preferred embodiment of the present invention, said compacts have an average weight per compact of less than or equal to 200 g, preferably less than or equal to 150 g, preferentially less than or equal to 100 g and in particular less than or equal to 50 g.

Advantageously, said compacts have an apparent density comprised between 1.5 and 3, advantageously between 1.5 and 2.8 and preferably between 1.7 and 2.6.

In an advantageous embodiment of the invention, said compact includes a through-orifice.

In an advantageous alternative, the composition according to the invention further comprises one or several oxides based on aluminum, in particular at a content comprised in the range from 1 to 30% and preferably from 5 to 20% by weight based on the total weight of the composition, expressed as Al₂O₃ equivalent, such as for example corundum, boehmite, or amorphous alumina.

In an advantageous alternative, the composition according to the invention further comprises one or several hydroxides based on aluminum, in particular at a content comprised in the range from 1 to 30% and preferably from 5 to 20% by weight based on the total weight of the composition, expressed as Al₂O₃ equivalent, such as for example boehmite, gibbsite or diaspore.

In an advantageous embodiment, the composition may comprise one or several oxides based on silicon, in particular at a content comprised in the range from 1 to 30% and preferably from 5 to 20% by weight, based on the total weight of the composition, expressed as SiO₂ equivalent, such as for example pyrogenated silica or precipitation silica.

In an advantageous embodiment, the composition may also comprise one or several hydroxides based on silicon, in particular at a content comprised in the range from 1 to 30%, and preferably from 5 to 20% by weight based on the total weight of the composition, expressed as SiO₂ equivalent.

In another embodiment, the composition according to the invention further comprises one or several oxides based on iron, in particular at a content comprised in the range from 1 to 30% and preferably from 5 to 20% by weight based on the total weight of the composition, expressed as Fe₂O₃ equivalent, such as for example hematite, magnetite, or wustite.

In another embodiment, the composition according to the invention further comprises one or several hydroxides based on iron, in particular at a content comprised in the range from 1 to 30% and preferably from 5 to 20% by weight based on a total weight of the composition, expressed as Fe₂O₃ equivalent, such as for example goethite or limonite.

In still another embodiment, the composition according to the present invention comprises one or several oxides based on manganese, in particular at a content comprised in the range from 1 to 10% and preferably from 1 to 5% by weight based on the total weight of the composition, expressed as MnO equivalent, such as for example pyrolusite or manganese monoxide MnO.

In still another embodiment, the composition according to the present invention comprises one or several hydroxides based on manganese, in particular at a content comprised in the range from 1 to 10% and preferably from 1 to 5% by weight based on the total weight of the composition, expressed as MnO equivalent.

In a preferred embodiment of the invention, the compact appears as a tablet.

The shape of these compact products is easily distinguished from that of rock calcium-magnesium compounds traditionally obtained after calcination of rock limestone or dolime.

Other embodiments of the composition according to the invention are indicated in the appended claims.

The present invention also relates to a composite material comprising several successive layers in order to form a multi-layer structure wherein at least one layer is formed with said compact product of the composition according to the invention.

Other embodiments of the composite materials according to the invention are indicated in the appended claims.

The present invention also relates to a method for producing a composition in the form of a compact comprising the following successive steps:
a) providing a composition of particles comprising at least particles of at least one calcium-magnesium compound fitting the formula aCaCO₃.bMgCO₃.xCaO.yMgO.zCa(OH)₂.tMg(OH)₂.uI, wherein I represents impurities, a, b, z, t and u each being mass fractions ≧0 and ≦50%, x and y each being mass fractions ≧0 and ≦100%, with x+y≧50% by weight based on the total weight of the calcium-magnesium compound, in a confinement space between two punches having a section comprised between 1 and 40 cm², advantageously comprised between 1 and 20 cm², preferably between 1 and 10 cm², in particular between 2 and 10 cm².
b) compacting said particles for forming a compact product of a three-dimensional shape, by applying a compaction pressure comprised between 200 MPa and 700 MPa, preferably comprised between 250 MPa and 500 MPa, more preferentially between 300 and 500 MPa, and even more preferentially between 375 and 490 MPa,
c) releasing the compaction pressure and
d) collecting said compact product.

Advantageously, the method comprises, prior to said provision step, a step for mixing the particles to form the composition of particles in order to obtain a homogeneous particle composition wherein the particles are homogeneously distributed in the particle composition in order to ensure good stability of the method and therefore good quality of the compacts.

The particle composition which is provided may contain, without however this being necessary, additives either of an organic nature such as for example conventional binders or lubricants, or of a mineral nature such as for example oxides or hydroxides based on aluminum, in particular in an amount from 1 to 30% and preferably from 5 to 20% expressed as Al₂O₃ equivalent, on silicon, in particular in an amount from 1 to 30% and preferably 5 to 20% expressed as SiO₂ equivalent, on iron, in particular an amount from 1 to 30% and preferably 5 to 20% expressed as Fe₂O₃ equivalent, on manganese in particular in an amount from 1 to 10% and preferably 1 to 5% expressed as MnO equivalent, or further mineral additives with a hardness greater than or equal to 5 on Mohs scale, characterized in that their particles have a size d₁₀₀ of less than or equal to 200 μm, preferably less than or equal to 150 μm and more preferentially less than or equal to 100 μm.

Advantageously, said step for providing the particle composition is controlled and occurs in such a way that it is always the same amount of said composition which is placed in said confined space between two punches.

In another embodiment of the method of the present invention, said confined space between said two punches is lubricated beforehand by means of a lubrication step during which a lubricant as a powder, such as for example calcium or magnesium stearate, is deposited at the surface of said confined space between said two punches, said lubricant as a powder being compacted with the particles of the particle composition and advantageously represents between 0.01 and 0.3% by weight, preferably between 0.02 and 0.1% by weight based on the total weight of the compact product. This embodiment therefore gives the possibility of external lubrication, i.e. lubrication of the punches and of the dies, which is more economical than internal lubrication, which consists of adding a lubricant directly within the composition to be compacted and which usually requires 0.25% to 1% by weight of lubricant. This further avoids adding complementary compounds into the composition to be compacted, thereby avoiding the risk of denaturation.

This method allows the formation of a compact based on one or several calcium-magnesium compounds having very good resistance to falling and good resistance to ageing.

Moreover, by considering the internal texture, this compact of said method will be distinguished from the products known to this day such as for example the briquettes which stem from shaping methods using presses with rollers. The compact according to the invention is free from macrodefects such as clefts, cracks or cleaving planes, unlike the products in the form of briquettes and the like known to this day which contain clefts from a few hundred micrometers to a few millimeters in length and from a few micrometers to a few hundred micrometers in width which may easily be detected by simple observation with the naked eye, with an optical microscope or else with a scanning electron microscope (SEM).

According to an embodiment, a rotary press is used for carrying out the compression, but generally, the compaction system may be of any type, for example, a hydraulic press may also be used. In principle, these compaction systems comprise a die inside which may slide one or two punches, these elements forming said confinement space in which the composition is placed for compaction.

It is the action of the punches which exerts the compaction stress required for forming the compact. This applied compaction stress may consist of bringing the composition to a determined compaction pressure, which corresponds for the confined space between the two punches to a certain volume and therefore to a certain position of the punches, and of optionally maintaining the position of these punches for a determined period of time which may range up to about fifty milliseconds, while being aware that maintaining this position for a longer duration is not detrimental, but does not have any additional benefit.

A rotary press with punches operates at high compaction pressures. In principle, the compaction system comprises a rotary platform having cavities forming dies in which may slide one or two punches, these elements forming a confinement space in which the composition is placed for compaction.

The geometry and the operation of a rotary press allows better transmission of the force on the product to be compacted, which generates better homogenization of the density distribution in the compact and therefore better mechanical strength and less structural defects.

The use of a rotary press for forming the compacted products based on calcium-magnesium oxides moreover gives the opportunity of better controlling the kinetics and kinematics of compaction with the possibility of pre-packing and/or pre-compaction giving the possibility of better densifying the powder and driving out the air thereby avoiding the formation of defects such as cleaving or capping.

Advantageously, in the method according to the present invention, said collective compact product is then heat-treated between 700° C. and 1,200° C. for a predetermined time period comprised between 1 and 90 minutes, preferably greater than or equal to 5 minutes and less than or equal to 60 minutes, more particularly greater than or equal to 10 minutes and less than or equal to 30 minutes.

Advantageously, the heat treatment is carried out above 800° C., advantageously above 900° C., and below 1,100° C., preferably below 1,000° C.

In a particular embodiment, the heat treatment moreover includes temperature raising and lowering ramps as short as possible so that the productivity of said heat treatment is optimum.

This method allows the formation of a compact based on one or several calcium-magnesium compounds having very good resistance to falling and very good resistance to ageing.

According to an embodiment, a horizontal oven such as for example a tunnel oven, a passage oven, a roller kiln or further a mesh belt kiln is used for carrying out the heat treatment. Alternatively, any other type of conventional oven, which will not lead to alteration of the integrity of the compacts, for example because of too large attrition, may be used.

In still another embodiment, the method according to the invention further comprises a step for surface treatment of said collected compact product, optionally after heat treatment if it is present, at a temperature greater than or equal to 50° C., preferably greater than or equal to 100° C., preferably greater than or equal to 150° C. and less than or equal to 700° C., advantageously less than or equal to 500° C., preferably less than or equal to 400° C., in particular less than or equal to 300° C., advantageously less than or equal to 250° C., for a time period greater than or equal to 5 minutes, preferably greater than or equal to 10 minutes, and less than or equal to 60 minutes, preferably less than or equal to 30 minutes under a gas flow containing CO₂ and water steam.

Advantageously, the gas flow comprises a water steam concentration greater than or equal to 5% by volume, and less than or equal to 25% by volume, preferably less than or equal to 15%.

Preferably the gas flow comprises a CO₂ concentration in the gas is greater than or equal to 5% by volume, preferably greater than or equal to 10% by volume, and less than or equal to 40% by volume, preferably less than or equal to 25% by volume.

More particularly, the gas flow used stems from combustion fumes, for example from a traditional lime kiln.

With this method it is possible to form a compact based on one or several calcium-magnesium compounds having very good resistance to falling and very good resistance to ageing.

According to an embodiment, a vertical counter-current reactor fed with compacts through the top and with gas through the bottom is used for carrying out said surface treatment.

Advantageously, the increase in the temperature of the compacts may be directly achieved via the injection of said gas already hot or preheated beforehand, as this would be the case for example from gas stemming from combustion fumes.

Although this is not necessary, the benefit will be well understood for economical, environmental and sustainable activity reasons for carrying out this surface treatment with combustion fumes rather than with synthetic gases containing carbon dioxide and water steam.

In one alternative, the present invention relates to a method for making composite material comprising several successive layers for forming a multi-layer structure wherein at least one layer is formed with said compact product of the composition by the method according to the invention and further comprising an additional step for compacting said at least one layer of said compact product and of another compact layer.

Other embodiments of the method according to the invention are indicated in the appended claims.

The object of the invention is also a use of the composite material according to the present invention or of the composition according to the present invention or stemming from the method according to the present invention in steel working, in particular in oxygen converters or in electric arc furnaces, in the treatment of flue gases, in the treatment of waters, in the treatment of waste sludges and waters, in agriculture, building industry and civil engineering such as for example for stabilizing soils.

Other forms of use according to the invention are indicated in the appended claims.

Other features, details and advantages of the invention will become apparent from the description given hereafter, in a nonlimiting way and with reference to the appended examples.

FIG. 1 is an SEM (acronym of <<Scanning Electron Microscopy>>) image at a magnification of 100 times, illustrating a quick lime compact formed according to the invention.

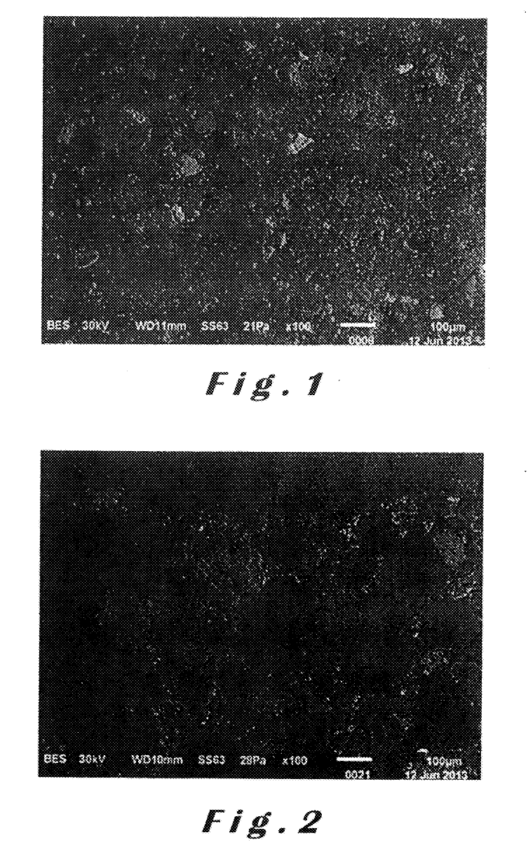

FIG. 2 is an SEM image at a magnification of 100 times, illustrating a quick dolomite compact formed according to the invention.

FIG. 3 is an SEM image at a magnification of 100 times, illustrating a quick dolomite briquette formed according to the prior art.

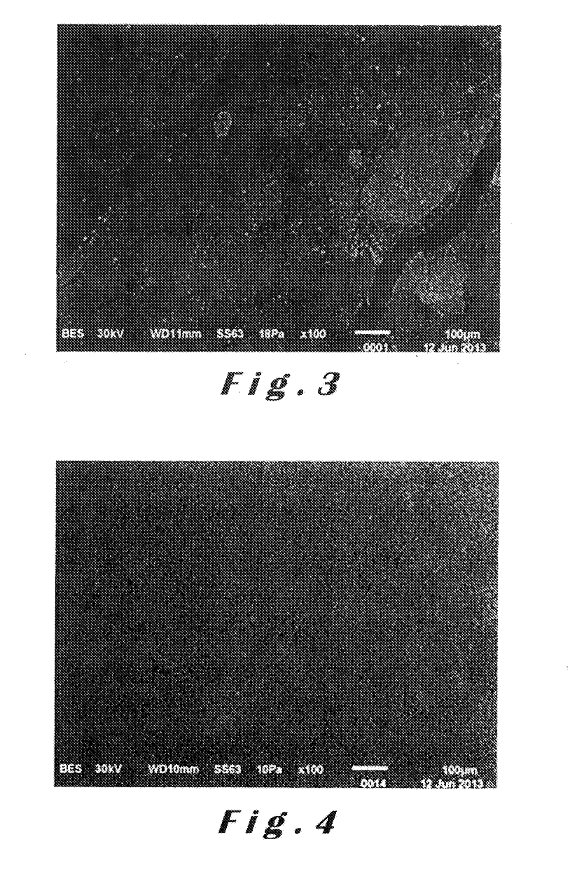

FIG. 4 is an SEM image at a magnification of 100 times, illustrating an sintered rock quick lime stemming from a rotary kiln.

### EXAMPLES

### Example 1

### Quick Lime Compacts

A rotary press Eurotab of the <<Mercury>> type is used. Starting with about thirty kilograms of quick lime fines of 0-3 mm, 9 g of these fines are successively poured into each of the dies of the tooling of cylindrical shape and with a diameter of 20 mm. Compression is carried out under a compression of 400 MPa, with a closing-in speed of the punches of 105 m/s and a maintaining time of 136 ms.

Several kilograms of cylindrical compacts each having a weight of 9 g and a dimension (diameter) of 20.4 mm are obtained. The height is 13.0 mm and the density is 2.1. These compacts are of a homogeneous quality and are free from macroscopic defects, as shown in FIG. 1 illustrating a photograph taken with a scanning electron microscope (SEM). They consist of juxtaposed particles beside each other.

These compacts develop a specific BET surface area (as measured by manometry with adsorption of nitrogen after degassing under vacuum at 190° C. for at least two hours and calculated according to the multipoint BET method as described in the ISO 9277:2010E standard) of 1.6 m²/g and have a total mercury pore volume of 35% (as determined by porosimetry by introduction of mercury according to part 1 of the ISO 15901-1:2005E standard which consists of dividing the difference between the skeleton density, measured at 30,000 psia, and the apparent density, measured at 0.51 psia, by the skeleton density).

A Shatter Test is performed starting with 0.5 kg of these compacts by successively performing 4 two-meter falls. The amount of fines of less than 10 mm, generated at the end of these 4 falls is weighed. A Shatter Test Index of 2.0% is obtained.

A Shatter Test is also conducted starting with 10 kg of these compacts by successively performing 4 two-meter falls. The amount of the fines of less than 10 mm generated at the end of these 4 fails is weighed. A Shatter Test Index of 3.2% is obtained. Moreover 0.5 kg of these compacts are subject to an Accelerated Ageing Test of Level 1 for 2 h at 30° C. under 75% of relative humidity (i.e. 22.8 g/m³ of absolute humidity). This leads to a 1.9% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 10.2% is obtained which also takes into account the fines of less than 10 mm generated by the ageing test.

### Example 2

### Compacts of Quick Dolomite or Dolime

A rotary press Eurotab of the <<Mercury>> type is used. Starting with about thirty kilograms of quick dolomite fines of 0-3 mm, 9 g of these fines are successively poured into each of the dies of the tooling with a cylindrical shape and a diameter of 20 mm. Compression is performed under a pressure of 400 MPa, with a closing-in speed of the punches of 105 mm/s and a maintaining time of 136 ms.

Several kilograms of compacts each having a weight of 9 g and a dimension (diameter) of 20.4 mm are obtained. The height is 13.0 mm and the density is 2.1. These compacts have homogeneous quality and are free of macroscopic defects, as shown in FIG. 2 illustrating a photograph taken with a scanning electron microscope (SEM). They consist of juxtaposed particles near each other.

These compacts develop a BET specific surface area of 3.6 m²/g and have a total mercury pore volume of 36%.

A Shatter Test is conducted starting with 0.5 kg of these compacts by successively performing 4 two-meter falls. The amount of fines of less than 10 mm generated at the end of these 4 falls is weighed. A Shatter Test Index of 2.2% is obtained.

A Shatter Test is also conducted starting with 10 kg of these compacts by successively performing 4 falls of 2 m. The amount of fines of less than 10 mm generated at the end of these 4 falls is weighed. A Shatter Test Index of 3.0% is obtained. Moreover 0.5 kg of these compacts are subject to an Accelerated Ageing Test of Level 4 for 2 h at 40° C. under 70% of relative humidity (i.e. 35.8 g/m³ of absolute humidity). This leads to a 2.1% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 17.9% is obtained.

Moreover 10 kg of these compacts distributed over a surface of 0.2 m² are subject to an ageing test for 7 h at 25° C. under 94% of relative humidity (i.e. 21.6 g/m³ of absolute humidity). A Shatter Test is then conducted starting with these 10 kg of aged compacts by successively performing 4 two-meter falls. The amount of fines of less than 10 mm generated at the end of these 4 falls is weighed. A Shatter Test Index of 18.5% is obtained.

### Example 3

### Compacts of Quick Lime and Quick Dolomite

A rotary press Eurotab of the <<Mercury>> type is used. Starting with about thirty kilograms of a mixture consisting of 50% of quick lime fines of 0-3 mm and of 50% of quick dolomite fines of 0-3 mm, 9 g of this mixture are successively poured in each of the dies of the tooling with a cylindrical shape and a diameter of 20 mm. Compression is performed under a pressure of 400 MPa, with a closing-in speed of the punches of 105 mm/s and a maintaining time of 136 Ms.

Several kilograms of compacts each having a weight of 9 g and a dimension (diameter) of 20.4 mm are obtained. The height is 13.0 mm and the density is 2.1. These compacts have homogeneous quality and are free of macroscopic defects.

These compacts develop a BET specific surface area of 2.4 m²/g and have a total mercury pore volume of 36%.

A Shatter Test is conducted starting with 0.5 kg of these compacts by successively performing 4 two-meter falls. The amount of fines of less than 10 mm generated at the end of these 4 falls is weighed. A Shatter Test Index of 1.9% is obtained.

Moreover 0.5 kg of these compacts are subject to an accelerated ageing test of Level 2 for 2 h at 40° C. under 50% of relative humidity (i.e. 26.6 g/m³ of absolute humidity). This leads to a 2.3% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 18.6% is obtained.

### Example 4

### Quick Lime Compacts

A rotary press Eurotab of the <<Titan>> type is used. Starting with about thirty kilograms of quick lime fines of 0-3 mm, 23 g of these fines are successively poured in each of the dies of the tooling with a cylindrical shape and a diameter of 26 mm. Compression is performed under a pressure of 400 Mpa, with a closing-in speed of the punches of 128 mm/s and a maintaining time of 80 ms.

Several kilograms of compacts are obtained, each having a weight of 23 g and a dimension (diameter) of 26.2 mm are obtained. The height is 23.3 mm and the density is 2.1.

These compacts develop a BET specific surface area of 1.6 m²/g and have a total mercury pore volume of 34%.

A Shatter Test is conducted starting with 0.5 kg of these compacts by successively performing 4 two-meter falls. The amount of fines of less than 10 mm generated at the end of these 4 falls is weighed. A Shatter Test Index of 2.3% is obtained.

Moreover 0.5 kg of these compacts are subject to an Accelerated Ageing Test of Level 1 for 2 h at 30° C. under 75% of relative humidity (i.e. 22.8 g/m³ of absolute humidity). This leads to a 1.9% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 8.7% is obtained, which also takes into account the fines of less than 10 mm generated by the ageing test.

### Example 5

### Quick Lime Compacts Containing 10% of Fe₂O₃

A powder mixer Gericke GCM450 is used with a capacity of 10 dm³, equipped with standard blades with a radius of 7 cm, used in rotation at 350 revolutions per minute (i.e. 2.6 m/s). This mixer is used in a continuous mode in order to prepare a mixture consisting of 90% by weight of quick lime fines of 0-3 mm and of 10% by weight of pre-dried iron ore powder Northland 0-50 μm (water content of 0.5% by weight). The total flow rate of the powder is 300 kg/h and the dwelling time is 3.5 s. The obtained mixture is very homogeneous. This means that the Fe₂O₃ content for different 10 g samples taken from the final mixture is always comprised between 9 and 11% (+/−10% relatively).

A rotary press Eurotab of the <<Titan>> type is used which is moreover equipped with an external lubrication system consisting of depositing on the surface of each cavity, upstream from the filling, 0.02% by weight of calcium stearate powder based on the weight of each compact. Starting with about thirty kilograms of the mixture, 9.4 g of this mixture are successively poured into each of the dies of the tooling with a cylindrical shape and a diameter of 20 mm. Compression is performed under a pressure of 450 MPa, with a closing-in speed of the punches of 204 mm/s and a maintaining time of 70 ms.

Several kilograms of compacts each having a weight of 9.4 g and a dimension (diameter) of 20.2 mm are obtained. The height is 13.0 mm and the density is 2.2. These compacts have homogeneous quality and are free from macroscopic defects.

These compacts develop a BET specific surface area of 1.4 m²/g and have a total mercury pore volume of 34%.

A Shatter Test is conducted starting with 0.5 kg of these compacts by successively performing 4 two-meter falls. The amount of fines of less than 10 mm generated at the end of these 4 falls is weighed. A Shatter Test Index of 2.9% is obtained.

### Example 6

### Quick Lime Compacts Containing 10% Fe₂O₃

Starting with the same mixture as the one prepared in Example 5, a rotary press Eurotab of the <<Titan>> type is used. 24 g of the mixture are successively poured into each of the dies of the tooling with a cylindrical shape and a diameter of 26 mm. Compression is performed under a pressure of 450 MPa, with a closing-in speed of the punches of 128 mm/s and a maintaining time of 80 ms.

Several kilograms of cylindrical compacts each having a weight of 24 g and a dimension (diameter) of 26.2 mm are obtained. The height is 20.2 mm and the density is 2.2.

These compacts develop a BET specific surface area of 1.6 m²/g and have a total mercury pore volume of 36%.

A Shatter Test is conducted starting with 0.5 kg of these compacts by successively performing 4 two-meter falls. The amount of fines of less than 10 mm generated at the end of these 4 falls is weighed. A Shatter Test Index of 2.7% is obtained.

Moreover 0.5 kg of these compacts are subject to an Accelerated Ageing Test of Level 1 for 2 h at 30° C. under 75% of relative humidity (i.e. 22.8 g/m³ of absolute humidity). This leads to a 1.9% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 8.1% is obtained which also takes into account the fines of less than 10 mm generated by the ageing test.

### Example 7

### Quick Lime Compacts (with Heat Treatment)

Starting with quick lime compacts of Example 1, 1 kg of these compacts are put into a hot electric oven and a 20 min heat treatment at 900° C. is carried out.

After cooling the compacts, a Shatter Test is then conducted starting with 0.5 kg of these compacts by successively performing 4 two-meter falls. The amount of fines of less than 10 mm generated at the end of these 4 falls is weighed. A Shatter Test Index of 0.9% is obtained.

These compacts develop a BET specific surface area of 1.2 m²/g and have a total mercury pore volume of 39%,

Moreover 0.5 kg of these compacts are subject to an Accelerated Ageing Test of Level 4 for 2 h at 40° C. under 70% of relative humidity (i.e. 35.8 g/m³ of absolute humidity). This leads to a 4.2% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 2.5% is obtained.

### Example 8

### Quick Dolomite Compacts (with Heat Treatment)

Starting with quick dolomite compacts of Example 2, 1 kg of these compacts is put into a hot electric oven and a heat treatment for 20 mins at 900° C. is carried out.

After cooling the compacts, a Shatter Test is then conducted starting with 0.5 kg of these compacts by successively performing 4 two-meter falls. The amount of fines of less than 10 mm generated at the end of these 4 falls is weighed. A Shatter Test Index of 1.0% is obtained.

These compacts develop a BET specific surface area of 2.8 m²/g and have a total mercury pore volume of 40%.

Moreover 0.5 kg of these compacts are subject to an Accelerated Ageing Test of Level 4 for 2 h at 40° C. under 70% of relative humidity (i.e. 35.8 g/m³ of absolute humidity). This leads to a 1.7% increase in the mass of these compacts. A Shatter Test is then conducted starting with these 0.5 kg of aged compacts by successively performing 4 two-meter falls. The amount of fines of less than 10 mm generated at the end of these 4 falls is weighed. A Shatter Test Index of 1.7% is obtained.

### Example 9

### Quick Lime Compacts (with Surface Treatment)

Starting with the compacts of quick lime of Example 1, 1 kg of these compacts are put into a hot electric oven and a surface treatment is conducted for 30 min at 200° C. under a flow of 20 dm/min of a gas containing 70% by volume of air, 20% by volume of CO₂ and 10% by volume of steam.

After cooling the compacts, a Shatter Test is then conducted starting with 0.5 kg of these compacts by successively performing 4 two-meter falls. The amount of fines of less than 10 mm generated at the end of these 4 falls is weighed. A Shatter Test Index of 1.2% is obtained.

These compacts develop a BET specific surface area of 1.6 m²/g and have a total mercury pore volume of 35%.

Moreover 0.5 kg of these compacts is subject to an Accelerated Ageing Test of Level 4 for 2 h at 40° C. under 70% of relative humidity (i.e. 35.8 g/m³ of absolute humidity). This leads to an increase in the mass of these compacts of 1.2%. A Shatter Test is then conducted starting with these 0.5 kg of aged compacts by successively performing 4 two-meter falls. The amount of fines of less than 10 mm is weighed. A Shatter Test Index of 1.5% is obtained.

### Comparative Example 1

### Quick Dolomite Briquettes

An industrial press with rollers of the Sahut-Conreur type is used. Starting with a few tons of dolime fines of 0-3 mm to which is added 0.25% of calcium stearate, these fines are compressed via the feed screw in the gap between the 2 compaction rollers. Briquettes are produced of about 20 cm³ obtained under a linear pressure of about 100 kN/cm. The briquettes have a weight of about 40-45 g each and a density of 2.2. These briquettes are of highly variable quality and they have macroscopic defects such as clefts and cracks as shown by FIG. 3 illustrating a photograph taken with an SEM. They have cleaving planes which are visible to the naked eye and are sometimes broken into several pieces.

These briquettes develop a BET specific surface area of 3.6 m²/g and have a total mercury pore volume of 34%.

A Shatter Test is conducted starting with 0.5 kg of these briquettes by successively performing 4 two-meter falls. The amount of fines of less than 10 mm generated at the end of these 4 falls is weighed. A Shatter Test Index of 13.9% is obtained.

A Shatter Test is also conducted starting with 10 kg of these briquettes by successively performing 4 two-meter falls. The amount of fines of less than 10 mm generated at the end of these 4 falls is weighed. A Shatter Test Index of 13.2% is obtained. Moreover 0.5 kg of these briquettes is subject to an Accelerated Ageing Test of Level 1 for 2 h at 30° C. under 75% of relative humidity (i.e. 22.8 g/m³ of absolute humidity). This leads to a 1.8% increase in the mass of these briquettes.

A Shatter Test is then conducted starting with these 0.5 kg of aged briquettes by successively performing 4 two-meter falls. The amount of fines of less than 10 mm generated at the end of these 4 falls is weighed. A Shatter Test Index of 50% is obtained.

Moreover 10 kg of these briquettes distributed over a surface of 0.2 m² are subject to an ageing test for 7 h at 25° C. under 94% of relative humidity (i.e. 21.6 g/m³ of absolute humidity). A Shatter Test is then conducted starting with these 10 kg of aged briquettes by successively performing 4 two-meter falls. The amount of fines of less than 10 mm generated at the end of these 4 falls is weighed. A Shatter Test Index of 60% is obtained.

### Comparative Example 2

### Quick Dolomite Briquettes

Starting with quick dolomite briquettes from Comparative Example 1, 1 kg of these briquettes are put into a hot electric oven and a heat treatment for 20 mins at 1,000° C. is carried out.

After cooling the briquettes, a Shatter Test is then conducted starting with 0.5 kg of these briquettes by successively performing 4 two-meter falls. The amount of fines of less than 10 mm generated at the end of these 4 falls is weighed. A Shatter Test Index of 10.6% is obtained.

These briquettes develop a BET specific surface area of 2.6 m²/g and have a total mercury pore volume of 35%.

### Comparative Example 3

### Quick Dolomite Briquettes

Starting with quick dolomite briquettes from Comparative Example 1, 1 kg of these briquettes are placed into a hot electric oven and a heat treatment for 2 h at 1,300° C. is carried out.

After cooling the briquettes, a Shatter Test is then conducted starting with 0.5 kg of these briquettes by successively performing 4 two-meter falls. The amount of fines of less than 10 mm generated at the end of these 4 falls is weighed. A Shatter Test Index of 6% is obtained.

These briquettes develop a BET specific surface area of 0.3 m²/g and have a total mercury pore volume of 18%.

### Comparative Example 4

### Sintered Rock Quick Lime from a Rotary Kiln

Sintered rock lime from a rotary oven is used, obtained starting with a rock lime limestone of 10-40 mm. The lime was therefore obtained at about 1,200-1,300° C. with a dwelling time of 5-6 hours.

This rock lime is of a homogeneous quality and is free of macroscopic defects as shown in FIG. 4 illustrating a photograph taken with scanning electron microscopy (SEM). In this image, a homogeneous surface is observed in which it is not possible to distinguish the constitutive particles of the overbaked rock lime.

### Comparative Example 5

### Quick Dolomite Briquettes

Starting with quick dolomite briquettes from Comparative Example 1, 1 kg of these briquettes are put into a hot electric oven and a heat treatment for 4 h at 1,400° C. is carried out.

After cooling the briquettes, a Shatter Test is then conducted starting with 0.5 kg of these briquettes by successively performing 4 two-meter falls. The amount of fines of less than 10 mm generated at the end of these 4 falls is weighed. A Shatter Test Index of 3.6% is obtained.

These briquettes develop a BET specific surface area of less than 0.2 m²/g and have a total mercury pore volume of 13%.

It is obvious that the present invention is by no means limited to the embodiments described above and that many modifications may be provided thereto without departing from the scope of the appended claims.

1. A composition comprising at least one calcium-magnesium compound having the formula
aCaCO₃.bMgCO₃.xCaO.yMgO.zCa(OH)₂.tMg(OH)₂.uI,
wherein I represents impurities, a, h, z, t and u each being mass fractions ≧0 and ≦50%, x and y each being mass fractions ≧0 and ≦100%, with x+y≧50% by weight, based on the total weight of said at least one calcium-magnesium compound, characterized in that said at least one calcium-magnesium compound is in the form of particles, said composition having an calcium and magnesium accrued content in the form of oxides, greater than or equal to 80% by weight based on the total weight of the composition, said composition being in the form of compacts, each compact being formed with said compacted and shaped particles of calcium-magnesium compounds, said compacts having a Shatter Test Index of less than 10%.

2. The composition according to claim 1, wherein said at least one calcium-magnesium compound has mass fractions such that x+y≧60% by weight, based on the total weight of said at least one calcium-magnesium compound.

3. The composition according to claim 1, wherein said compacts have a Shatter Test Index of less than 8%.

4. The composition according to claim 1, wherein the calcium and magnesium accrued content in the form of oxides is greater than or equal to 90% by weight based on the total weight of the composition.

5. The composition according to claim 1, having a specific surface area measured by manometry with adsorption of nitrogen after degassing under vacuum at 190° C. for at least 2 hours and calculated according to the multi-point BET method as described in the ISO 9277:2010E standard, greater than or equal to 0.4 m²/g.

6. The composition according to claim 1, having a total pore volume determined by porosimetry with intrusion of mercury according to Part 1 of the ISO 15901-1:2005E standard, greater than or equal to 20%.

7. The composition according to claim 1, having a Shatter Test Index of less than 20% after an Accelerated Ageing Test of Level 1 at 30° C. under 75% of relative humidity (i.e. 22.8 g/m³ of absolute humidity) for 2 h.

8. The composition according to claim 1, having a Shatter Test Index of less than 20% after an Accelerated Ageing Test of Level 2 at 40° C. under 50% of relative humidity (i.e. 25.6 g/m³ of absolute humidity) for 2 h.

9. The composition according to claim 1, having a Shatter Test Index of less than 20% after an Accelerated Ageing Test of Level 3 at 40° C. under 60% of relative humidity (i.e. 30.7 g/m³ of absolute humidity) for 2 h.

10. The composition according to claim 1, having a Shatter Test Index of less than 20% after an Accelerated Ageing Test of Level 4 at 40° C. under 70% of relative humidity (i.e. 35.8 g/m³ of absolute humidity) for 2 h.

11. The composition according to claim 1, further comprising an organic additive such as a binder or a lubricant.

12. The composition according to claim 1, wherein said particles have a size of less than or equal to 7 mm, observable by optical microscopy or by scanning electron microscopy and before compaction having a size of particles d₁₀₀ of less than or equal to 7 mm.

13. The composition according to claim 1, wherein said particles of said at least one calcium-magnesium compound before compaction have a d₉₀ of less than or equal to 3 mm.

14. The composition according to claim 1, wherein said particles of said at least one calcium-magnesium compound before compaction have a d₅₀ of less than or equal to 1 mm.

15. The composition according to claim 1, wherein said compacts are of a regular and homogeneous shape, characteristic of products obtained by methods for shaping fines via a dry route, said shapes being selected from the group consisting of pellets, tablets, compressed tablets, briquettes, platelets, pebbles and <<soap bar>> shapes and have a size comprised between 10 and 100 mm.

16. The composition according to claim 1, wherein said compacts have an average weight per compact of at least 1 g.

17. The composition according to claim 1, wherein said compacts have an average weight per compact of less than or equal to 200 g.

18. The composition according to claim 1, wherein said compacts have an apparent density comprised between 1.5 and 3.

19. The composition according to claim 1, wherein said compact includes a through-orifice.

20. The composition according to claim 1, further comprising one or several oxides, said oxides being selected from the group consisting of an oxide based on aluminum, an oxide based on silicon, an oxide based on iron, an oxide based on manganese.

21. The composition according to claim 1, further comprising one or several hydroxides, said hydroxides being selected from the group consisting of a hydroxide based on aluminum, a hydroxide based on silicon, a hydroxide based on iron, a hydroxide based on manganese.

22. The composition according to claim 1, wherein said compact is free of macrodefects, on the basis of simple visual inspection, of inspection under an optical microscope or further of inspection with a scanning electron microscope (SEM).

23. A composite material comprising several successive layers for forming a multi-layer structure wherein at least one layer is formed with said compact product of the composition according to claim 1.

24. A method for making a composition in the form of a compact comprising the following steps:
providing a composition of particles comprising at least particles of at least one calcium-magnesium compound fitting the formula
aCaCO₃.bMgCO₃.xCaO.yMgO.zCa(OH)₂.tMg(OH)₂.uI,
wherein I represents impurities, a, b, z, t and u each being mass fractions ≧0 and ≦50%, x and y each being mass fractions ≧0 and ≦100%, with x+y≧50% by weight based on the total weight of the calcium-magnesium compound in a confinement space between two punches having a section comprised between 1 and 40 cm²,
compacting said particles for forming a compact product with a three-dimensional shape, by applying a compaction pressure comprised between 200 MPa and 700 MPa,
releasing the compaction pressure and
rejecting said compact product from said confinement space.

25. The method according to claim 24, comprising, prior to said provision step, a step for mixing the particles in order to form the composition of particles in order to obtain a homogeneous composition of particles wherein the particles are homogeneously distributed in the composition of particles.

26. The method according to claim 24, wherein said composition of particles which is provided, contains additives selected from the group consisting of additives of an organic nature including conventional binders or lubricants, and additives of a mineral nature including oxides or hydroxides based on aluminum, silicon, iron, manganese and the like, and further additives with a hardness greater than or equal to 5 on the Mohs scale, said additives having a size of particles d₁₀₀ of less than or equal to 200 μm.

27. The method according to claim 24, wherein said space confined between said two punches is lubricated beforehand by means of a lubrication step during which a lubricant in the form of a powder, including calcium or magnesium stearate, is deposited at the surface of said space confined between said two punches, said lubricant in the form of a powder being compacted with the particles of the composition of particles and represents advantageously between 0.01 and 0.3% by weight based on the total weight of the compact product.

28. The method according to claim 24, wherein said collected compact product is then heat-treated between 700° C. and 1,200° C. for a predetermined time period comprised between 1 and 90 minutes.

29. The method according to claim 28, wherein said collected compact product is heat-treated at more than 800° C. and at less than 1,100° C.

30. The method according to claim 24, further comprising a step for surface treatment of said collected compact product, optionally after heat treatment if it is present, at a temperature greater than or equal to 50° C., and less than or equal to 700° C., for a time period greater than of equal to 5 minutes under a flow of gas containing CO₂ and water steam.

31. The method according to claim 24, wherein said gas flow has a water steam concentration greater than or equal to 5% by volume.

32. The method according to claim 24, wherein said flow of gas has a CO₂ concentration in the gas greater than or equal to 5% by volume and less than or equal to 40% by volume.

33. A method for making a composite material comprising several successive layers in order to form a multi-layer structure wherein at least one layer is formed with said compact product of the composition by the method according to claim 24 and further comprising an additional compaction step for said at least one layer of said compact product and for another compact layer before said ejection step.

34. (canceled)
